(19) United States
(12) Patent Application Publication
(10) Pub. No.: US 2014/0040402 A1
(43) Pub. Date: Feb. 6, 2014

(54) SYSTEM AND METHOD FOR PREVENTING UNWANTED ELECTRONIC COMMUNICATIONS

(71) Applicants: Adrian Samuel Johnson, Land O' Lakes, FL (US); Jarred A. Ligatti, Tampa, FL (US); Dinesh Divakaran, College Station, TX (US)

(72) Inventors: Adrian Samuel Johnson, Land O' Lakes, FL (US); Jarred A. Ligatti, Tampa, FL (US); Dinesh Divakaran, College Station, TX (US)

(73) Assignee: UNIVERSITY OF SOUTH FLORIDA, Tampa, FL (US)

(21) Appl. No.: 14/048,079

(22) Filed: Oct. 8, 2013

Related U.S. Application Data
(63) Continuation of application No. PCT/US2012/035526, filed on Apr. 27, 2012.
(60) Provisional application No. 61/479,579, filed on Apr. 27, 2011.

(51) Int. Cl. H04L 12/58

(52) U.S. Cl. CPC H04L 51/12
USPC 709/206

(57) ABSTRACT

An email system, configured by creating a user controlled email domain for each user, rather than a dedicated email address. The user is then allowed to create unlimited email addresses within the user controlled email domain. The system and method of the present invention provides improved policing of unwanted email communications. When unwanted communications on a compromised email address are detected, they can be identified and effortlessly subverted while known communicators may continue use of the compromised email address.

### FIELD OF INVENTION

This invention relates to the processing of electronic communications and more particularly, to indentifying and blocking unsolicited or unwanted email communications.

### BACKGROUND OF INVENTION

Publicly accessible communication addressing systems such as emails, IPs, ports, phones, post boxes, and instant messages (IMs) provide little privacy and much opportunity for abuse. Once an unwanted communicator learns of a desirable target's address, they may choose to begin regularly misusing and sharing that address with others. Anonymous communication and source spoofing make identification of culprits and information leaks difficult. Further, enforcement deficiencies such as lack of power, jurisdiction, and effective punishments often amount to multiple levels of unbridled harassment as leaked address information continues to propagate over time. Ultimately, email address abandonment by the recipient of the unwanted communication may become an unfortunately appealing option, despite destructive ramifications.

Once an email recipient reveals their email address to anyone, they lose control over how and by whom it is used. Revealing an email address may result in unwanted junk mail and spam. It is also very difficult to stop the sender of the spam from passing the email address to others, thereby increasing the unwanted email communication. Roughly 14.5 billion spam messages are sent globally every day. Spam email makes up roughly half of all emails sent globally, and the United States is the largest spam email generator.

Disposable Email Address (DEA) systems are known in the art that provide an effective means for controlling compromised communications channels, however DEA systems have not been broadly adopted because they require eliminating the unwanted email by disposing of an email address that has become compromised, which also results in the elimination of wanted emails to the disposed of address. Additionally, DEAs rely upon restrictive, unnatural naming conventions and management interfaces which are not user friendly.

Accordingly, what is needed in the art is a user-friendly system and method for preventing unwanted emails from reaching a user email inbox that does not require the user to abandon a compromised email address.

### SUMMARY OF INVENTION

In accordance with the present invention, technology may be implemented within an existing email system to prevent unwanted emails from reaching a user inbox that does not require the user to abandon compromised email addresses.

In a particular embodiment of the present invention, a computer-implemented method for preventing the reception of unwanted emails at a user inbox may include, creating a user controlled email domain that is associated with a user inbox at which the user desires to receive email. The user may then be allowed to create a plurality of to-addresses associated with the user controlled email domain. When email is then received at the user controlled email domain from one of a plurality of from-addresses, the method may further determine if the to-address associated with the received email is an unknown to-address, an uncompromised to-address or a compromised to-address. If the received email to-address is an unknown to-address, the received email may be delivered to a pending approval queue of the user controlled email domain. If the received email to-address is an uncompromised to-address the received email may be delivered to the user inbox. If the received email to-address is a compromised to-address, the method may then determine if the received email from-address is a trusted from-address and if the received email is a trusted from-address, the received email may be delivered to the user inbox. Alternatively, if the received email is not from a trusted from-address, the received email may be rejected and not delivered to the user inbox.

The present invention may further include the ability of the user to apply the method of preventing unwanted emails from reaching a user inbox to existing email domains that are not controlled by the user. In a specific embodiment, emails received at an existing email domain that is not controlled by the user are forwarded to the user controlled email domain. In an additional embodiment, the user may be provided with the ability to create to-addresses within the user uncontrolled email domain. Additionally, subdomains may be created within the user uncontrolled email domain, thereby allowing a user to create to-addresses within a user controlled subdomain of a user uncontrolled email domain.

If an email is received having an unknown to-addresses and the email is subsequently stored in a pending queue, the user will be given the opportunity to either approve or reject the received email having the unknown to-address. In a specific embodiment, the user may be given a limited period of time in which to either approve or reject the unknown to-address. If the user approves the unknown to-address, the email will be delivered to the user inbox and the to-address will now be considered an uncompromised to-address. If the user rejects the unknown to-address, the email will be rejected and the to-address will be considered a compromised to-address. If the user does not respond to the email having an unknown to-address with the specified period of queue time, the email may be automatically deleted or archived.

An electronic email system in accordance with an embodiment of the present invention may include, a plurality of user controlled email domains, each of the plurality of user controlled email domains associated with a user inbox at which a user desires to receive email, and a plurality of to-addresses created by a user, each of the plurality of to-addresses associated with one of the plurality of controlled user email domains. In this electronic email system, when an email is received at one of the plurality of controlled email domains, an email delivery unit may determine if the to-address associated with a email received at one of the plurality of user controlled email domains is an unknown to-address, an uncompromised to-address or a compromised to-address. If the received email to-address is an unknown to-address, the received email may be delivered to a pending approval queue of the user controlled email domain, where the received email will await approval or rejection of the unknown to-address. If the received email to-address is an uncompromised to-address, the received email may be delivered to the user inbox. If the received email to-address is a compromised to-address, it may then be determined if the received email from-address is a trusted from-address and if the from-address is a trusted from-address, the email may be delivered to the user inbox. Alternatively, if the from-address is not a trusted from-address, the email may be rejected and will not be received at the user inbox.

With the system and method of the present invention, technology may be implemented within an existing email system to prevent unwanted emails from reaching a user inbox that does not require the user to abandon compromised email addresses.

### BRIEF DESCRIPTION OF THE DRAWINGS

For a fuller understanding of the invention, reference should be made to the following detailed description, taken in connection with the accompanying drawings, in which:

FIG. 1 is a diagram illustrating the system for preventing the reception of unwanted emails in accordance with the present invention.

FIG. 2 is a flow-diagram illustrating the method for preventing the reception of unwanted emails in accordance with the present invention.

### DETAILED DESCRIPTION OF THE INVENTION

In the following detailed description of the preferred embodiments, reference is made to the accompanying drawings, which form a part hereof, and within which are shown, by way of illustration, specific embodiments by which the invention may be practiced. It is to be understood that other embodiments may be utilized and structural changes may be made without departing from the scope of the invention.

Technology may be implemented within an existing email system to prevent unwanted emails from reaching a user inbox that does not require the user to abandon compromised email addresses.

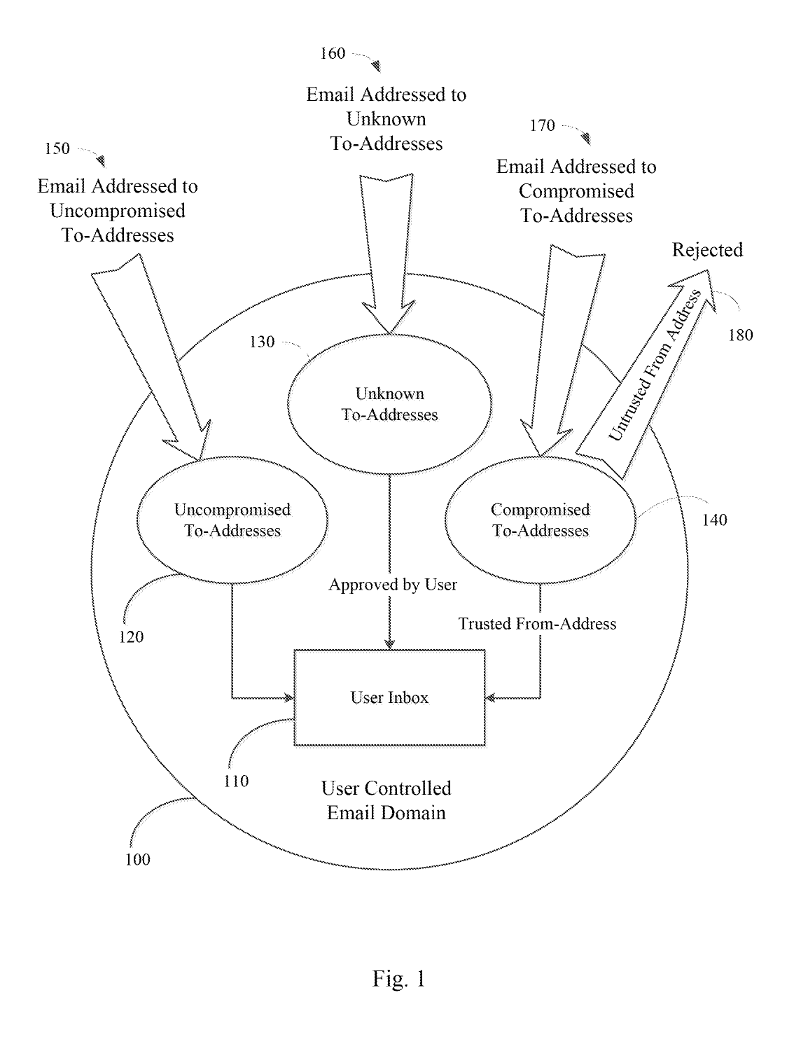

With reference to FIG. 1, in the present invention, a user controlled email domain 100 is established. This user controlled email domain 100 may be established through an existing mail transfer agent. The user controlled email domain may be a subdomain of an existing email domain. In a specific embodiment, the user controlled email domain may be established utilizing Exim. Exim is known in the art as a mail transfer agent (MTA) commonly used on Unix-like operating systems. Exim installations are commonly used by internet service providers.

The user controlled email domain 100 is associated with a user inbox 110 to which the user desires to receive email. The user can create an unlimited number of to-address that include the user controlled email domain 100 associated with the user inbox 110. The present invention allows for an on-the-fly, unrestrictive, to-address naming convention. With this invention, the user can create to-addresses in any configured, creative, or identifying scheme, as long as the address is unique within the users controlled email domain. The to-addresses can be unique to a specific business or individual as determined by the user. In operation, the user may communicate the created to-address to a business or individual from which the user desires to receive email communications. Within the user controlled email domain 100, there may be a number of to-address in one of three states: uncompromised to-addresses 120, unknown to-addresses 130 and compromised to-addresses 140. Uncompromised to-addresses 120 are to-addresses which have not yet received any unwanted email. Unknown to-address 130 are to-addresses that have been created by the user and have received email, but the to-address has not yet been approved by the user. Compromised to-addresses 140 are to-addresses that have previously received unwanted email, and as such, are in a compromised state. With this system, uncompromised to-addresses 120 that receive unwanted email, as identified by the user, will be downgraded to from an un-compromised state to compromised state 140. Additionally, unknown to-addresses 130 that are approved by the user will subsequently become uncompromised to-addresses 140.

In operation, email addressed to an uncompromised to-address 150 arrives at the user controlled email domain and is delivered to the user inbox 110. Email addressed to an unknown to-address 160 is held in a queue, pending approval of the unknown to-address by the user. If the user approves the unknown to-address, the email from the unknown to-address 130 is delivered to the user inbox 110. Email addressed to a compromised to-address 170 is further analyzed before being delivered to the user inbox 110. The from-address of email addressed to a compromised to-address 170 is analyzed to determine if the from-address is a trusted from-address. A from-address is identified as a trusted from-address unless the user has previously identified the from-address as an untrusted from-address. If the from-address of the email addressed to the compromised to-address 170 is not from a trusted from-address, the email is rejected and is not delivered to the user inbox 110. If the from-address of the email addressed to the compromised to-address 170 is from a trusted from-address, the email is delivered to the user inbox 110. In this way, unwanted email is prevented from reaching the user inbox without making it necessary to dispose of a compromised email address.

Email received at an uncompromised to-address is automatically whitelisted and delivered to the user inbox. However, when a user receives an unwanted email (i.e. SPAM) at a specific uncompromised to-address, the user may identify the specific to-address as a compromised to-address and the user may identify the from-address associated with the unwanted email as from an untrusted from-address. When email is received at the now compromised to-address, the from-address of the email received at a compromised to-address will determine whether or not the email is delivered to the user inbox. If the from-address is identified as a trusted from-address, the email will be delivered to the user inbox. However, if the from-address is identified by the user as an untrusted from-address, the email will be rejected. Accordingly, email can still be received at the compromised to-address and delivered to the user inbox if the from-address in a trusted from-address and the user does not have to abandon the to-address to prevent unwanted email (i.e. from untrusted from-addresses) from reaching the user inbox. As such, the delivery of email from already known communicators can be continued on compromised to-addresses and delivery integrity can be maintained by preventing unwanted communication from reaching the user inbox. Additionally, once unwanted communications on a compromised to-address are detected, they can be identified, effortlessly subverted, and possibly even prosecuted while trusted communicators can continue use of the address and/or update to a new address as desired.

When a user creates an email to-address on-the-fly, the email to-address may not be recognized yet by the user controlled email domain. When an email is received at the user controlled email domain from the to-address that the user generated on-the-fly, it will be considered an unknown to-address. Email from an unknown to-address is held in queue pending approval of the to-address by the user. The user can specify a caching time period, such as one week, where emails with unknown to-addresses may be temporarily stored. In this way, the user will not need to anticipate that an unknown to-address will be received and the user can have up to one week, or other user specified time, to review the unknown to-address and to either approve or deny the unknown to-address. If the unknown to-address is approved, the to-address will then be treated as an uncompromised to-address. If the unknown to-address is denied the emails will be discarded. If the unknown to-address is neither approved nor denied by the user, the email may be discarded after the expiration of the queue time period.

In an exemplary implementation, the present invention may be implemented on Exim and courier SMTP, POP3 and IMAP systems, without requiring any additional coding, utilizing a free web-based user interface, such as Vexim, that allows for managing new email addresses, forwarding email, and creating domains on the fly by manipulating an underlying database table. The functionality required by the present invention is readily attainable on most deployed mail systems without the need for any internal code modification. In a specific embodiment, a subdomain is created for each user, rather than an email address. The users are then allowed to create their own unlimited email addresses within the created subdomain. The ability to create subdomains is available in most server web consoles.

In an exemplary embodiment, if a provider, such as GMAIL™, implemented the system of the present invention, a user could register the subdomain johndoe.gmail.com. The user would then be free to enable unrestricted, creative and informative to-addresses such as “meds100312@johndoe.gmail.com” to communicate with a favorite medication distribution website initiating communication on Mar. 12, 2010. For example, the user may use the initiation date as a marker to help identify when the address was issued. If that address is later compromised, the user can change the address to a similar address, but perhaps with a new initiation date. Assuming that valuable order information and savings opportunities are communicated to John through this to-address, John continues to want the email received at this to-address.

After John has established this to-address with the medication distribution website, a website affiliated with the medication distribution website also begins marketing exciting new products to John addressed to the same to-address. John determines that this email from this affiliated website is wanted email. A month later, John may begin receiving email from a different source, having a different from-address, at the same to-address. John may determine that the email received from the different source is unwanted email and may identify the from-address of this source as an untrusted from-address. As soon as John identifies the unwanted email as being from an untrusted from-address, the email from the untrusted from-address will be rejected. John may then update his email with the affiliate site to perhaps, 2meds100412@johndoe.gmail.com. As such, John will continue to permit any previously whitelisted communicators (i.e. trusted from-addresses on meds100312@johndoe.gmail.com) through to his user inbox, but will reject the untrusted from-addresses. In this manner, all unwanted senders having untrusted from-addresses are now rejected and wanted email is still delivered to the to-address meds100312@johndoe.gmail.com, unhindered. Furthermore, when the new email address 2meds100312 also becomes compromised, John will be able to pinpoint the exact source of the breach.

As mentioned earlier, in an exemplary implementation, the present invention may be implemented on an Exim and courier SMTP, POP3 and IMAP system utilizing the web-based user interface called Vexim. In a specific implementation, in the first month, two to-addresses were pre-configured. Ten unknown to-addresses were created. By the second month, two to-addresses were identified as compromised and then downgraded to compromised to-addresses. In the third month, 15 unknown to-addresses were created and three more to-addresses were compromised and downgraded to compromised to-addresses. Once downgraded to the state of a compromised to-addresses, the system of the present invention will reject the spam and prevent the unwanted email from reaching the user inbox.

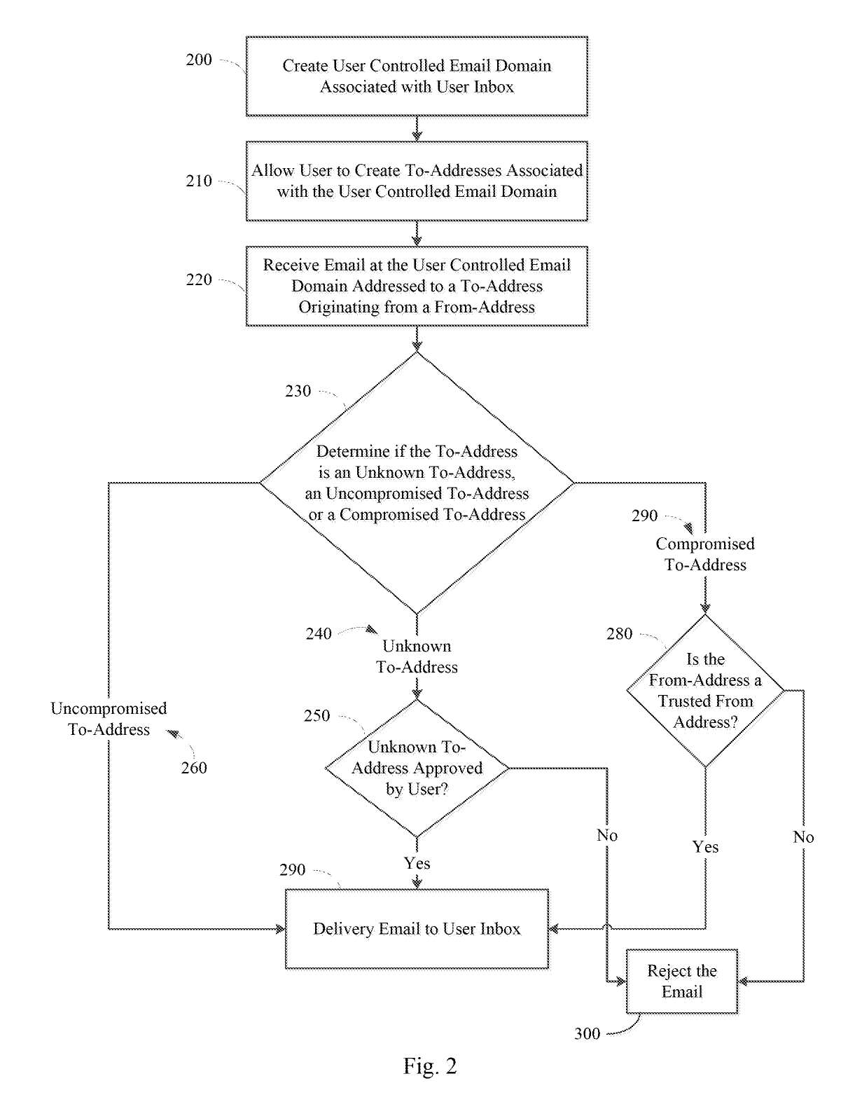

With reference to FIG. 2, a flow-diagram illustrating a method of preventing the reception of unwanted emails at a user inbox is provided in accordance with an embodiment of the present invention. In this embodiment, a user controlled email domain is created that is associated with a user inbox 200. The user is then allowed to create unlimited to-addresses associated with the user controlled email domain 210. As email is received at the user controlled email domain 220, the method of the present invention is used to determine if the to-address of the received email is an unknown to-address, an uncompromised to-address or a compromised to-address 230. If the to-address of the received email is an uncompromised to-address 260, the email is delivered to the user inbox 290. If the to-address of the received email is an unknown to-address 240, the email is held in a queue pending approval by the user 250. If the user subsequently approves the unknown to-address, the email is delivered to the user inbox 290. If the subsequently does not approve the unknown to-address, the email is rejected 300. If the to-address of the received email is a compromised to-address 270, it is then determined if the from-address of the received email is a trusted from-address 280. If the from-address of the received email is not trusted from-address, the email is rejected 300. If the from-address of the received email is a trusted from-address, the email is delivered to the user inbox 290.

In the practical implementation of the present invention, step-by-step instructions and RPM packages can be created for each popular mail system so that mail administrators interested in enabling spam prevention utilizing the present invention can easily set up the proper environment. For a system administrator performing software installation and maintenance, the use of package management (RPM) rather than manual building has advantages, such as simplicity, consistency and the ability for these processes to be automated and non-interactive. The RPM package may be stored on a non-transitory computer readable medium for ease of distribution and use. On the user side, a universal specific web console including the necessary elements to implement the present invention may be provided that can interface with all popular mail servers. The web console may support custom rules for on-the-fly generation of to-addresses. Phone applications and email client pluggins may be developed to support those who would like to generate their own naming conventions to encode data for automation such as business domain verification.

The present invention may also be expanded to prevent DOS or other network attacks on IP address and port forwarding schemes. The present invention may be used to address text messaging advertising on phones, which is an emerging problem in many countries.

Conventional spam filters may be used in combination with the present invention to further increase the protection of the user inbox. The system of the present invention works in combination with most common spam solutions and even synergizes with domain wide systems such as collaborative filtering. Razor, Brightmail, and DCC spam traps are opened up to be utilized by individuals because internet mail providers may be un-trustable because they sell penetration to the highest bidder.

The present invention avoids the unnecessary “disposal” of addresses, which is core to DEAs. There is no equitable benefit to the DEA solution of “all or nothing” elimination of addresses other than to appease the current mental model of manual email account management. A computer does not mentally balk at listening on an entire email domain, rejecting emails from known compromised addresses, and forwarding whitelisted emails to a user inbox.

The present invention provides users with increased flexibility and insight without requiring widespread adoption, enforcing difficult tradeoffs, enforcing rules, or requiring major changes in paradigm. Many users find it desirable to be able to choose multiple unrestricted addresses to fit their creativity. It has been argued that DEAs in general decrease the value of email as a marketing tool. However, in contrast, the present invention merely provides users with increased control over what marketing they wish to receive and provides users with a means to recover from all too common abuses of trust.

In an exemplary implementation, on the protocol side, the present invention includes a software add-on to the Exim mail system which monitors SMTP (Simple Mail Transfer Protocol) traffic. On the user application side, the present invention includes a PHP hypertext preprocessor web-based user interface which looks and feels much like any major email client but with the extra functionality needed to make use of the protocol of the present invention.

The inventive protocol may intercept received email at a user controlled domain, and read the to-address and the from-address from the received email.

on event(mail-received) read(to-address, from-address)

The protocol may direct all email addressed to to-addresses that are unknown to-addresses into a temporary holding queue pending the user's approval of the unknown to-address. The unknown to-addresses are held in a temporary queue to allow the user to create new to-address on the fly (i.e. while filing in a web form or when meeting a new person at a conference). The amount of time the unknown to-address spend in the holding queue time is configurable so that the user need only take action to approve desirable unknown to-addresses at his or her leisure (i.e. two weeks) and all incoming mail with unexpected/unapproved to-addresses will not clutter or disturb the user and will eventually auto-archive or auto-delete effortlessly.

if (to-address.isnew) temp_queue.add(mail), pending-to-addresses.add(to-address)

Once an unknown to-address has been approved, the from-address of all incoming mail that is desirable (not actively marked as undesirable by the user or a Bayesian spam filter) is then added to a database of trusted from-addresses (i.e. auto-whitelisted). This is done so that if a to-address, which the user has previously approved, ever becomes compromised (observed/guessed) by a malicious spammer the to-address can then be identified as a compromised to-address. This protocol could also be used when transitioning an existing email address to the user controlled email domain. In this case, the from-addresses of the emails received at the existing email address that is being transitioned will be auto-whitelisted until such time that the existing email address becomes compromised. The reason spammers cannot be stopped once they find a user (with current systems) is because they can send to the user from many (real or forged) from-addresses, subverting the user's ability to block (blacklist) them. With this protocol, the user simply marks the to-address the spammer has discovered as compromised. Note: It is unlikely a spammer would guess a to-address the user has approved from a nearly infinite set of possible to-addresses at the user's disposal so the user would never see their undesired mail even if they could determine the user were using this protocol.

if (to-address.whitelisted) maiLdeliverto(spamswat box),

until (from-address.blacklisted) from-address.whitelist

Once any to-address is marked as compromised, only mail coming in from trusted from-addresses (all your previously auto-whitelisted correspondents) are delivered to your inbox. This relieves the user from the need to totally abandon or tediously monitor a mature to-address. Unfortunately, the more mature and utilized an address is, the more spam it receives. Most original Yahoo™ and AOL™ accounts are laden with spam but are vital to maintain because old contacts will unpredictably use them at any moment.

if (to-address.compromised) deliveronly(mail.from-address.whitelisted)

Additional embodiments of the invention may allow the user to consolidate many email addresses from diverse mail domains such as Yahoo™ and AOL™ accounts, which may be considered uncontrolled domains. In a specific embodiment, email that was sent by a sender having a specific from-address, to a Yahoo™ mail account (i.e. user@yahoo.com) will now be forwarded to the user controlled email domain and when received at the user controlled email domain, tagged as coming by way of the Yahoo™ mail account. As such, the Yahoo™ mail is presented to the user in a single protected, consolidated inbox. This allows the user to incorporate any current email addresses at uncontrolled domains. This provides the protocol of the present invention with a means for of seamless backwards integration into, and user migration from, most legacy protocols, systems, and devices.

if (mail.forwarded) mail.tag(intermediate-address)

Furthermore, the protocol may allow a user to create and manage many new to-addresses at uncontrolled domains. An API (Application Programming Interface) to make use of the protocol and add-on software may be implemented on uncontrolled domains to allow corporate employees or contractors the ability to effortlessly create and connect such accounts to their protected single inbox. This provides the protocol a method of seamless forward integration into new protocols, systems, and devices.

if (lowest_subdomain.invalid and lowest_subdomain.equals(valid_username)) mail.forwardto(spam swat box)

As described, the present invention may be embodied in software stored on a non-transitory computer readable medium and the method of the present invention may be implemented on a computer system, such as an email server and a personal computer.

Extensive research on spam and unsolicited commercial email (UCE) has been undertaken in recent decades and complex defense systems have been deployed. Alas, SPAM prevails. With the present invention, spam can be eradicated while naming conventions remain open to user creativity. This seems likely to occur because users will be empowered to identify and prosecute spammers and will have an easy way to ignore spam as well as recover from compromises.

As is commonly known in the art for electronic mail systems, the present invention may be implemented by a combination of both hardware and software components. Known hardware components may include programmed computers including processors and memory modules, such as an email server commonly employed in internet mail or as a corporate level solution. Software components may include mail transfer agents running on the email server and user interface modules provide at a user's computer through software stored on the computer itself or provided to the user via the internet.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

What is claimed is:

1. A computer-implemented method for preventing the reception of unwanted emails at a user inbox, the method comprising:
creating a user controlled email domain, the user controlled email domain associated with a user inbox at which the user desires to receive email;
allowing the user to create a plurality of to-addresses associated with the user controlled email domain;
receiving an email at the user controlled email domain from one of a plurality of from-addresses, the received email associated with one of the plurality of to-addresses created by the user;
determining if the to-address associated with the received email is an unknown to-address, an uncompromised to-address or a compromised to-address; and
if the received email to-address is an unknown to-address, delivering the received email to a pending approval queue of the user controlled email domain; or
if the received email to-address is an uncompromised to-address, delivering the received email to the user inbox; or
if the received email to-address is a compromised to-address, determining if the received email from-address is a trusted from-address and delivering the received email to the user inbox if the from-address is a trusted from-address, or rejecting the received email if the received email from-address is not a trusted from-address.

2. The computer implemented method of claim 1, further comprising, prior to receiving the email at the user controlled email domain:
receiving the email at a user uncontrolled email domain;
identifying an intermediate from-address associated with the uncontrolled email domain;
forwarding the email to the user controlled email domain from the user uncontrolled email domain and identifying the received email from address as the intermediate from-address.

3. The computer implemented method of claim 1, further comprising, prior to receiving the email at the user controlled email domain:
creating a subdomain for the user within a user uncontrolled email domain;
allowing the user to create a plurality of to-addresses associated with the user uncontrolled email domain; and
forwarding the email to the user controlled email domain from the user uncontrolled email domain.

4. The computer-implemented method of claim 1, wherein creating the user controlled email domain further comprises, creating the user controlled email domain as a subdomain of a user uncontrolled email domain.

5. The computer-implemented method of claim 1, further comprising, after delivering the received email to a pending approval queue:
identifying a pending approval queue time;
delivering the received email to the user inbox if the user identifies the unknown to-address as an uncompromised to-address prior to an expiration of the pending approval queue time;
rejecting the received email if the user identifies the unknown to-address as a compromised to-address prior to the expiration of the pending approval queue time; and
archiving or deleting the received email if the user does not identify the unknown to-address prior to the expiration of the pending approval queue time.

6. The computer-implemented method of claim 1, further comprising:
receiving an email at the user controlled email, the received email associated with an uncompromised to-address and a from-address;
identifying the received email as an unwanted email;
changing the identification of the uncompromised to-address to a compromised to-address; and
identifying the from-address as an untrusted from-address.

7. A non-transitory computer readable medium on which a computer-readable program is stored that causes a computer to execute a method comprising:
creating an email subdomain within an email domain, the email subdomain associated with a user inbox at which the user desires to receive email;
allowing the user to create a plurality of email to-addresses associated with the email subdomain;
receiving an email at the email subdomain from one of a plurality of from-addresses, the received email associated with one of the email to-addresses created by the user;
determining if the to-address associated with the received email is a new to-address, a non-compromised to-address or a compromised to-address; and
if the received email to-address is a new to-address, delivering the received email to a pending approval queue of the email subdomain; or
if the received email to-address is a non-compromised to-address, delivering the received email to the user inbox; or
if the received email to-address is a compromised to-address, determining if the received email from-address is a trusted from-address and delivering the received email to the user inbox if the from-address is a trusted from-address or rejecting the received email if the received email from-address is not a trusted from-address.

8. The computer readable medium of claim 7, wherein the method further comprises, prior to receiving the email at the user controlled email domain:
receiving the email at a user uncontrolled email domain;
identifying an intermediate from-address associated with the uncontrolled email domain;
forwarding the email to the user controlled email domain from the user uncontrolled email domain and identifying the received email from address as the intermediate from-address.

9. The computer readable medium of claim 7, wherein the method further comprises, prior to receiving the email at the user controlled email domain:
creating a subdomain for the user within a user uncontrolled email domain;
allowing the user to create a plurality of to-addresses associated with the user uncontrolled email domain; and
forwarding the email to the user controlled email domain from the user uncontrolled email domain.

10. The computer readable medium of claim 7, wherein creating the user controlled email domain further comprises, creating the user controlled email domain as a subdomain of a user uncontrolled email domain.

11. The computer readable medium of claim 7, wherein the method further comprises, after delivering the received email to a pending approval queue:
identifying a pending approval queue time;
delivering the received email to the user inbox if the user identifies the unknown to-address as an uncompromised to-address prior to an expiration of the pending approval queue time;
rejecting the received email if the user identifies the unknown to-address as a compromised to-address prior to the expiration of the pending approval queue time; and
archiving or deleting the received email if the user does not identify the unknown to-address prior to the expiration of the pending approval queue time.

12. The computer readable medium of claim 7, wherein the method further comprises:
receiving an email at the user controlled email, the received email associated with an uncompromised to-address and a from-address;
identifying the received email as an unwanted email;
changing the identification of the uncompromised to-address to a compromised to-address; and
identifying the from-address as an untrusted from-address.

13. An electronic email system comprising:
a plurality of user controlled email domains, each of the plurality of user controlled email domains associated with a user inbox at which a user desires to receive email;
a plurality of to-addresses created by a user, each of the plurality of to-addresses associated with one of the plurality of controlled user email domains;
an email delivery unit to determine if the to-address associated with a email received at one of the plurality of user controlled email domains is an unknown to-address, an uncompromised to-address or a compromised to-address; and
if the received email to-address is an unknown to-address, delivering the received email to a pending approval queue of the user controlled email domain; or
if the received email to-address is an uncompromised to-address, delivering the received email to the user inbox; or
if the received email to-address is a compromised to-address, determining if the received email from-address is a trusted from-address and delivering the received email to the user inbox if the from-address is a trusted from-address, or rejecting the received email if the received email from-address is not a trusted from-address.

14. The electronic email system of claim 13, further comprising, a plurality of user uncontrolled email domains, each of the user uncontrolled email domains having an intermediate from-address and email received at the user uncontrolled email domains being forwarded to one of the plurality of the user controlled email domains.

15. The electronic email system of 13, further comprising, a plurality of user uncontrolled email domains having a plurality of user controlled email subdomains and a plurality of user created to-addresses associated with the user controlled email subdomains.

16. The electronic email system of claim 13, wherein the email delivery unit further comprises, after delivering the received email to a pending approval queue:
identifying a pending approval queue time;
delivering the received email to the user inbox if the user identifies the unknown to-address as an uncompromised to-address prior to an expiration of the pending approval queue time;
rejecting the received email if the user identifies the unknown to-address as a compromised to-address prior to the expiration of the pending approval queue time; and
archiving or deleting the received email if the user does not identify the unknown to-address prior to the expiration of the pending approval queue time.

17. The electronic email system of claim 13, wherein the email delivery unit further comprises:
receiving an email at the user controlled email, the received email associated with an uncompromised to-address and a from-address;
identifying the received email as an unwanted email;
changing the identification of the uncompromised to-address to a compromised to-address; and
identifying the from-address as an untrusted from-address.
